(19) United States
(12) Patent Application Publication
(10) Pub. No.: US 2026/0034614 A1
(43) Pub. Date: Feb. 5, 2026

(54) DEPLOYMENT MECHANISM FOR WELDING TORCH

(71) Applicant: Phillips Corporation, Hanover, MD (US)

(72) Inventor: Randolph C. Behm, III, Hanover, MD (US)

(73) Assignee: Phillips Corporation, Hanover, MD (US)

(21) Appl. No.: 19/288,445

(22) Filed: Aug. 1, 2025

Related U.S. Application Data
(60) Provisional application No. 63/678,104, filed on Aug. 1, 2024.

(51) Int. Cl. B23K 37/02; B23K 9/095

(52) U.S. Cl. CPC B23K 37/0211; B23K 9/0956; B23K 37/0247

(57) ABSTRACT

The invention is a deployment mechanism for a tool with a torch/head having: a mount, which is a plate for securing the parts the deployment mechanism directly or indirectly; cam plates with two cam tracks secured to the mount; a carriage assembly comprising: cam plate linkages movably and rotatably connected to the cam plates, and a tool mounting assembly for mounting the tool thereon, the tool mounting assembly being rotatably connected to the cam plate linkage; a linear actuator secured to the mount; and a linear actuator linkage for coupling the linear actuator with the carriage assembly; whereby the carriage assembly can move by the action of the linear actuator along the two cam plate tracks and as a result move the tool into position above a workpiece.

### BACKGROUND OF THE INVENTION

### 1. Field of the Invention

The subject invention is related to a device affixed to a machine tool such as a computer numerical control (CNC) milling machine that houses and deploys a welding torch/head (laser or arc based) for the purpose of moving the torch/head into a working position for use and retracting it for protection when not in use. More particularly, the present invention relates to a 2-stage motion that allows the working end of the torch/head to move close to the machine spindle after extending out of the enclosure.

### 2. Description of the Related Art

Additive manufacturing, also known as layered manufacturing, rapid prototyping, or less formally as 3D printing, is an important family of fabrication techniques for the production of a wide variety of objects and components.

In traditional manufacturing, parts are made from raw metal through subtractive processes that use machinery such as a mill or a lathe to cut away unwanted material and thereby obtain a desired shape. In additive manufacturing (AM), parts are built from a raw material powder or liquid that is built up layer by layer until an entire piece has been completed.

Selective laser melting machines (SLM) were developed which allowed for the AM of metal powders. SLM is a process where metal powder is deposited on a build plate, then melted in a fast pass by a high energy laser. Once the melted powder has fused, another layer of powder is coated onto the build plate and this process is repeated.

Other additive manufacturing processes include direct metal laser sintering (DMLS), Wire/Arc Additive Manufacturing (WAAM), Directed Energy Deposition (DED), Hybrid Manufacturing, and Hotwire Deposition (HWD), etc.

### SUMMARY OF THE INVENTION

These and other aspects and advantages of the subject invention will become more readily apparent from the following description of the preferred embodiments taken in conjunction with the drawings.

One aspect of the invention is a deployment mechanism for a tool with a torch/head having:
a mount, which is a plate for securing the parts the deployment mechanism directly or indirectly;
a cam plate with two cam tracks secured to the mount;
a carriage assembly comprising:
   a cam plate linkage movably and rotatably connected to the cam plate, and
   a tool mounting assembly for mounting the tool thereon, the tool mounting assembly being rotatably connected to the cam plate linkage;
a linear actuator secured to the mount; and
a linear actuator linkage for coupling the linear actuator with the carriage assembly;
whereby the carriage assembly can move by the action of the linear actuator along the two cam plate tracks and as a result move the tool into position above a workpiece.

Another aspect of the invention is a deployment mechanism for a tool with a torch/head having:
a mount, which is a plate for securing the parts the deployment mechanism directly or indirectly;
a cam plate with two cam tracks secured to the mount;
a carriage assembly comprising:
   a cam plate linkage movably and rotatably connected to the cam plate, and
   a tool mounting assembly for mounting the tool thereon, the tool mounting assembly being rotatably connected to the cam plate linkage and movably connected to a linear guide rail;
a linear actuator secured to the mount;
a linear actuator linkage for coupling the linear actuator with the carriage assembly; and
the linear guiderail secured to the mount and movably connected to the tool mounting assembly;
whereby the carriage assembly can move by the action of the linear actuator along the two cam plate tracks and as a result move the tool into position above a workpiece.

Still a further aspect of the invention is a system for a deployment mechanism for a tool with a torch/head with feedback control, the system having:
an operable assembly, in a single system, comprising:
a mount, which is a plate for securing the parts the deployment mechanism directly or indirectly;
a cam plate with two cam tracks secured to the mount;
a carriage assembly comprising:
   a cam plate linkage movably and rotatably connected to the cam plate,
   a tool mounting assembly for mounting the tool thereon, the tool mounting assembly being rotatably connected to the cam plate linkage, and
   a sensor to determine the position of the carriage assembly;
a linear actuator secured to the mount; and
a linear actuator linkage for coupling the linear actuator with the carriage assembly; and
a processor, the processor being configured to:
receive data from the position sensor;
determine whether or not the tool is in the correct position when fully deployed;
generate an alarm if the tool is not in the correct position when fully deployed; and
send a signal to a device working on the workpiece to halt operation so that all work is terminated and no energy is transmitted to the tool.

### BRIEF DESCRIPTION OF THE DRAWINGS

So that those skilled in the art to which the subject invention appertains will readily understand how to make and use the method and device of the subject invention without undue experimentation, preferred embodiments thereof will be described in detail herein below with reference to certain figures, wherein:

FIG. 1 is a perspective view of a first embodiment of present invention with an exploded view of one of the cam plate linkages;

FIG. 1A is a perspective view of a second embodiment the present invention with only a single cam plate, showing a view of the carriage assembly attached to a single cam plate;

FIG. 2 is a front view of the first embodiment of the present invention;

FIG. 3 is a perspective view of a cam plate;

FIG. 4 is a perspective view of the cam plate with the cam plate linkage which is guided by the cam plate;

FIG. 5 is a perspective view of the cam plate with an exploded view of the cam plate linkage attached to a tool mounting plate;

FIG. 6 is a perspective view of the first embodiment of the present invention with the cam plate with an exploded view of the cam plate linkage attached to the tool mounting plate which is holding a tool;

FIG. 6A is a perspective view of the second embodiment of the present invention with only the single cam plate, showing the carriage assembly connected to the cam plate linkage which is mounted on the single cam plate;

FIG. 7 is a perspective view of the first embodiment of the present invention with the cam plate linkage attached to the tool mounting plate which is holding the tool;

FIG. 8 is a perspective view of the first embodiment of the present invention with an area of detail designated by the letter “A”;

FIG. 9 is an expanded view of Detail A of a specific area of the present invention designated by “A” in FIG. 8;

FIG. 10 is a perspective view of both cam plates of the first embodiment of the present invention with cam plate linkages connected to the tool mounting plate;

FIG. 11 is a side view of the tool in the fully retracted/stowed position at a top of the cam plate;

FIG. 12 is a side view of the tool in a position at a bottom of the cam plate at the end of Stage 1 which is the mid-position of the device and the beginning of Stage 2;

FIG. 13 is a side view of the tool in a position at the bottom of the cam plate which is the completed Stage 2 position where the tool is in the fully extended or working position and has pivoted/rotated into position near the spindle centerline of a device for working on a workpiece;

FIG. 14 is a side view of the present invention shown in the working environment where the invention is attached to the device for working on a workpiece;

FIG. 15 is a side view of a cover or housing for the present invention;

FIG. 16 is a top view of a machine plate for a workpiece showing the present invention achieves 45.6% more working area on the machine plate holding the workpiece;

FIG. 17 is a perspective view of the first embodiment of the invention with an accessory plate and an enlarged view of Detail A;

FIG. 18 is the conventional art with a side view showing the position of a tool head relative to the working piece centerline in the conventional art; and

FIG. 19 illustrates an example communication network utilized with one or more of the illustrated embodiments;

FIG. 20 illustrates an example network device/node utilized with one or more of the illustrated embodiments; and

FIG. 21 illustrates a diagram depicting a feedback control system utilized with one or more of the illustrated embodiments.

### DETAILED DESCRIPTION OF THE INVENTION

Preferred embodiments of the present invention are described below with reference to the accompanying drawings, in which like reference numerals represent the same or similar elements.

The disclosed methods, systems and processes leverage unique software and hardware to configure a manufacturing device that is capable of conducting process development and planning, dimensional analysis, pre-machining, surface preparation, fume extraction, and post machining in a single integrated manufacturing and repair device. The manufacturing and repair device can include a main sealed (vacuum or inert gas) or unsealed chamber and an antechamber operably connected to provide sealed or unsealed communication therebetween. The main chamber and the antechamber are both operably connected, preferably in sealed or unsealed communication, with a machine tool chamber. The main chamber can contain an articulated robot with a machine, application or joining tool. The deployment mechanism 1000 of the present invention can be integrated into the main chamber of the manufacturing and repair device.

The machining chamber can be configured with a variety of machine tools, such as a multi-axis machine tool that is operably configured with a part scanner, pallet handling/transfer system, automatic tool changer.

Unique software code is written to integrate software packages which to allow full programming of the entire repair or manufacturing process from initial laser scan and or dimensional probing with the multi-axis machine tool, to pre-machining of the part, to the operation inside the main chamber, back to post machining and final dimensional probing or nondestructive inspection. Thus, a machined part or a part to be repaired can be moved in a scaled or unsealed environment between the main chamber and the machine tool chamber through the antechamber.

The deployment mechanism 1000 for a welding head of the present invention has six main operably connected components, a cam plate 100, a cam plate linkage 200, a tool mounting assembly 300, a linear actuator 400, a linear actuator linkage 500 and a linear guiderail 600. The combination of cam plate linkage 200 and tool mounting assembly 300, comprise a substructure referred to as a carriage assembly 700. The deployment mechanism 1000 is mounted on a mount 800 which is a plate for securing the parts the deployment mechanism directly or indirectly.

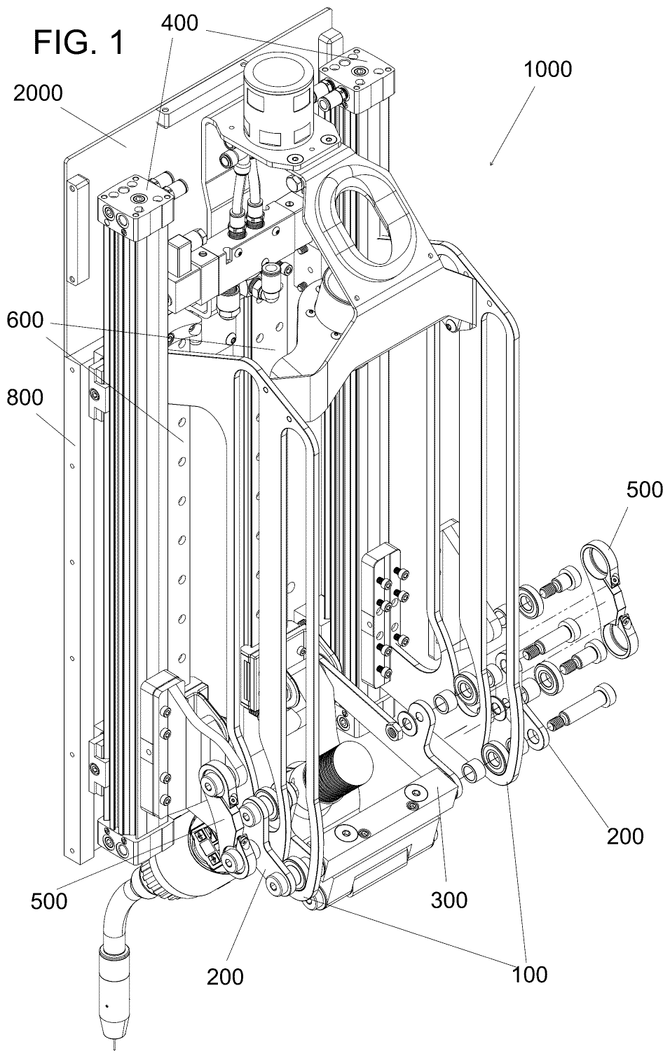

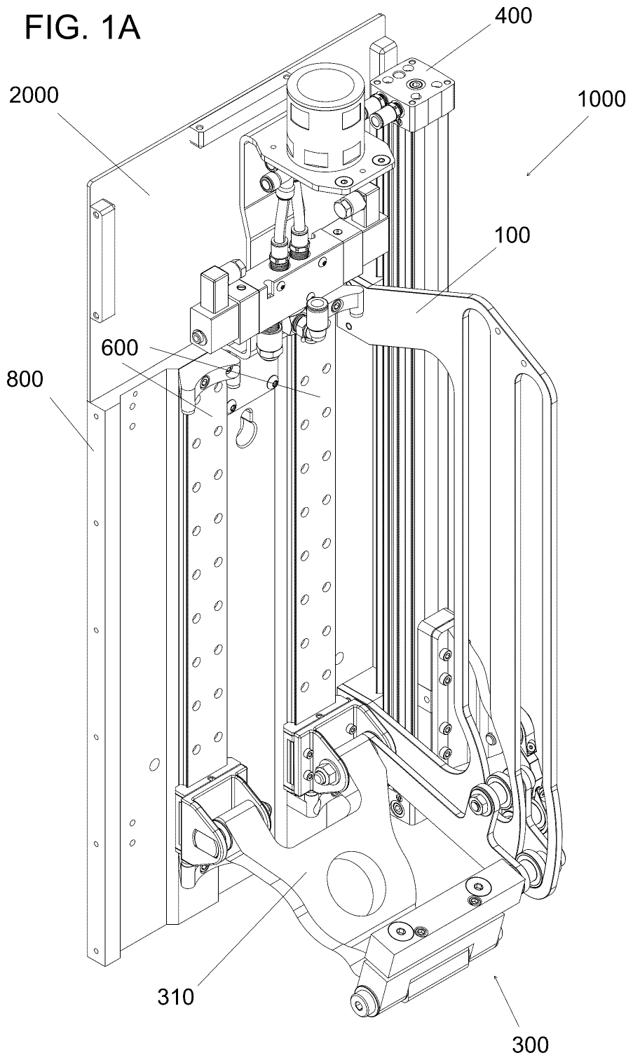

FIG. 1 shows a first embodiment of the deployment mechanism 1000 with at least two cam plates 100 mounted on opposite sides of carriage assembly 700. With at least two cam plates 100, the deployment mechanism 1000 also has two cam plate linkages 200, two linear actuator linkages 500 and two linear actuators 400. Additional cam plates of various sizes can be added for the purpose of altering the motion of the carriage assembly 700 and/or the pivot motion of the carriage assembly which is described as “2-stage” motion but could have additional stages like “3-stage” motion, “4-stage” motion, “5-stage” motion, “6-stage” motion and more.

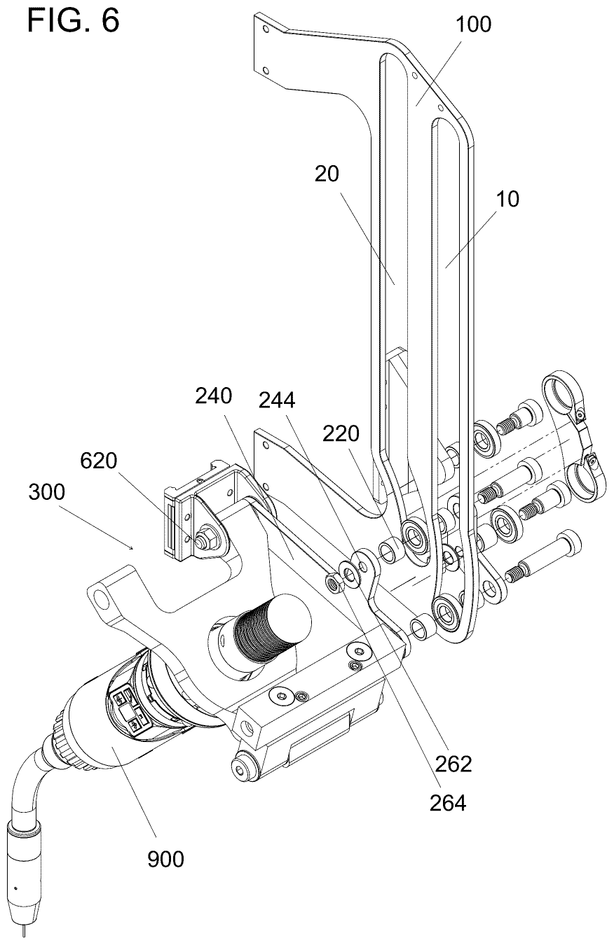

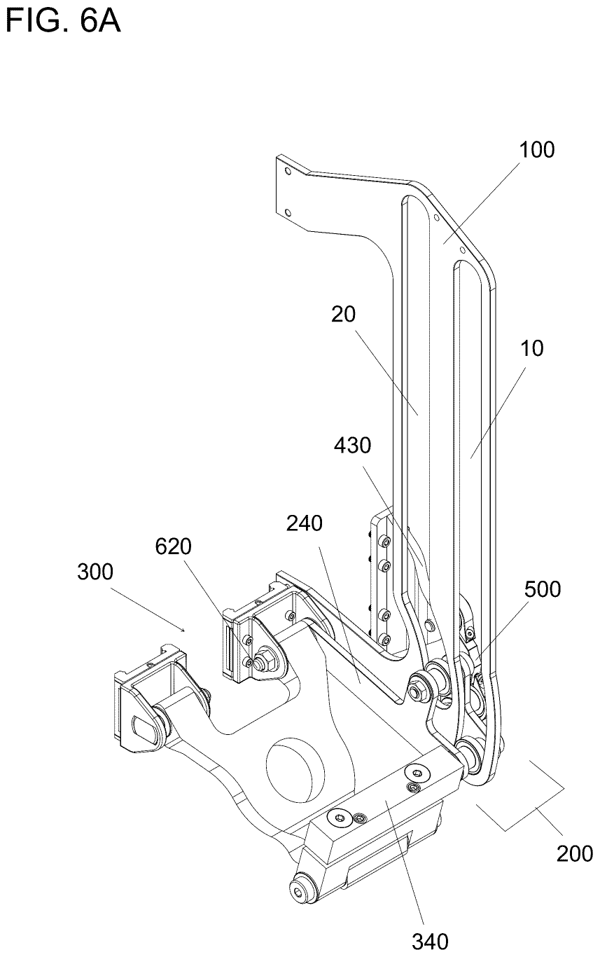

FIG. 1A and FIG. 6A show a second embodiment of the deployment mechanism 1000 with only a single cam plate 100 connected to the carriage assembly 700. The second embodiment has only one cam plate linkage 200, only one linear actuator linkage 500 and only one linear actuator 400. The advantage of the second embodiment single cam plate 100 design is that the size of the deployment mechanism 1000 can be smaller, lighter and more compact. In the second embodiment the only one cam plate linkage 200, only one linear actuator linkage 500 and only one linear actuator 400 all perform the same function as when there are a plurality or more than one of each item, as in the first embodiment. In the description below, the description of the singularity or plurality of the elements is not intended to be limiting to one or more than one, but rather it is understood that the element or part functions the same in the first embodiment and the second embodiment, thus the description of the element can apply to its use in either or both embodiments. The number of cam plate(s) 100 used in the deployment mechanism 1000 depends on the particular use application and thus the description of one element or part applies to its use with one or more cam plate(s).

Also shown in FIG. 6A is no threaded hole on the end of the tool angle adjustment block 340 because with only a single cam plate 100, there is no cam plate linkage on the opposite side of carriage assembly 700 for connection, and thus no threaded hole is created.

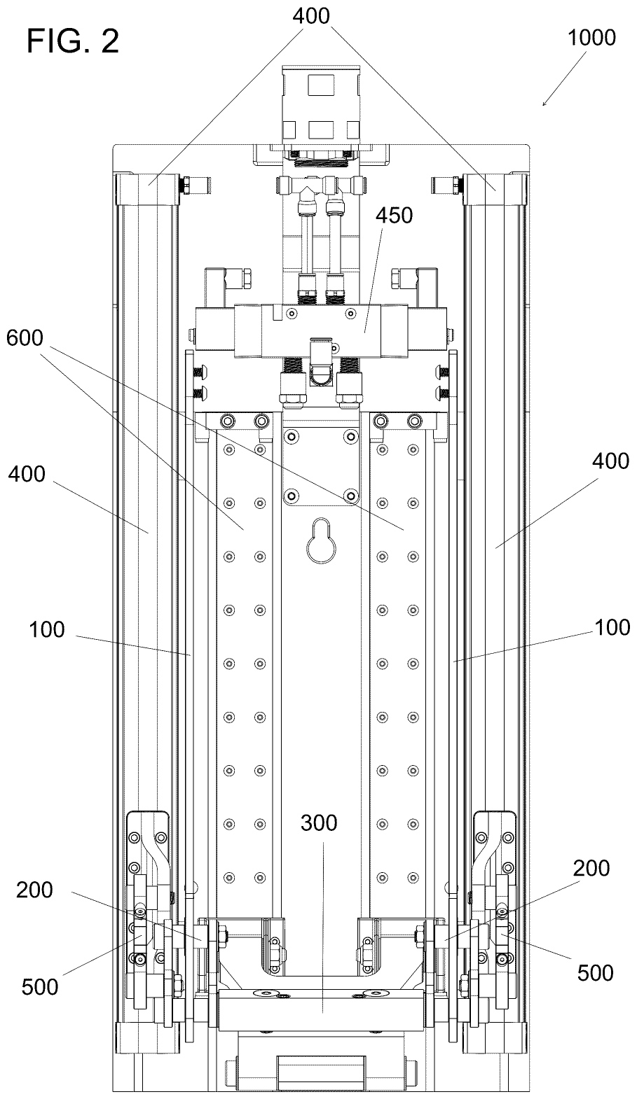

FIGS. 1 and 2 show the deployment mechanism 1000 for a welding head/torch operably assembled. The deployment mechanism 1000 of FIG. 1 is shown attached to mount 800 for mounting on a side wall of a device (not shown) for performing work on a workpiece (not shown). The deployment mechanism 1000 is also operably connected to a power source (not shown), which can be a pneumatic, a hydraulic, an electric (alternating current (AC) or a direct current (DC)) or mechanical power source for actuating linear actuators 400.

### Cam Plate

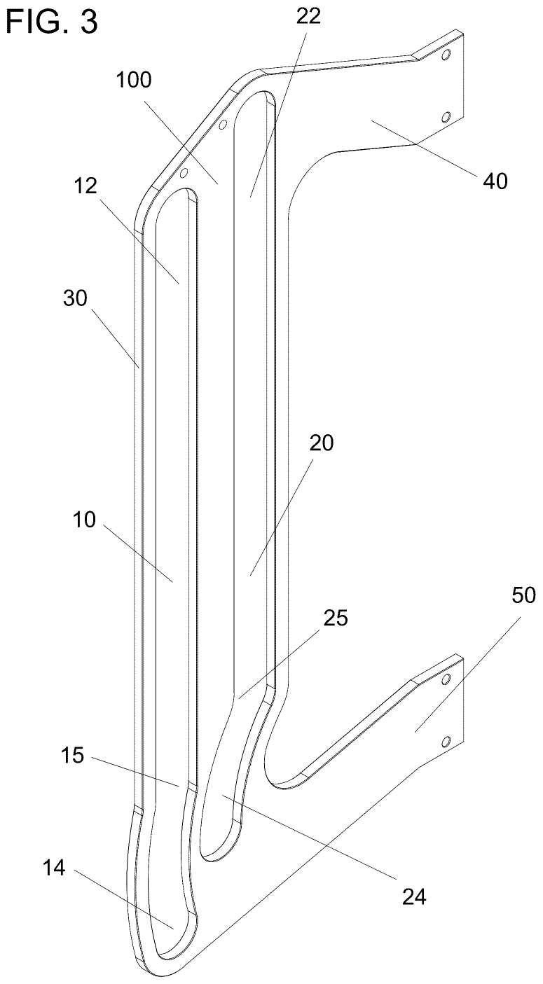

The main function of cam plate 100 is to provide two cam tracks for an articulated linkage with rollers to roll inside each cam track. In the embodiment shown in FIG. 3, cam plate 100 has a cam track 10 located closest to a longitudinal edge 30 of cam plate 100 and a cam track 20 located between cam track 10 and ends 40 and 50 for mechanically fastening cam plate 100 to mount 800 or a part connected to mount 800. Cam plate 100 can have more than 2 cam tracks and associated cam plate linkages, depending on the desired motion for the carriage assembly 700.

Cam track 10 is a cut-out portion of cam plate 100 having parallel inner surfaces to hold a roller, a pin, ball bearings or a part therebetween while such roller, pin, ball bearings or part moves along cam track 10. In the embodiment in FIG. 3, cam track 10 is linear for about 70 to 80% of its length and then cam track 10 curves at an inflection point 15 for the remainder of the length of cam track 10. Both ends of cam track 10 are rounded to match the roller, the pin, ball bearings or the part therein. Cam track 10 can be described as having linear section 12 and curved section 14.

Cam track 20 is a cut-out portion of cam plate 100 having parallel inner surfaces to hold a roller, a pin, ball bearings or a part therebetween while such roller, pin, ball bearings or part moves along cam track 20. In the embodiment in FIG. 3, cam track 20 is linear for about 70 to 80% of its length and then cam track 20 curves at an inflection point 25 for the remainder of the length of cam track 20. Both ends of cam track 20 are rounded to match the roller, pin, ball bearings or the part therein. Cam track 20 can be described as having linear section 22 and curved section 24.

A radius of curvature of curved section 12 of cam track 10 and a radius of curvature of curved section 22 of cam track 20 are different. As will be described later, motion of the carriage assembly 700 along curved section 14 of cam track 10 and curved section 22 of cam track 20 results in a movement of the a tool head through an arc of about 30° at the beginning of Stage 2 to the end of Stage 2 of the two stage motion.

Cam plates 100 serve multiple functions including the following: guiding the carriage assembly 700 along a path of motion; invoking a pivot/rotation motion that makes up the 2-stage motion of the deployment mechanism 1000, providing outboard support for the carriage assembly 700 to register against in the working position; and providing a repeatable hard stop while removing the need to construct a skeleton or cage around the carriage assembly 700 to mount end stops.

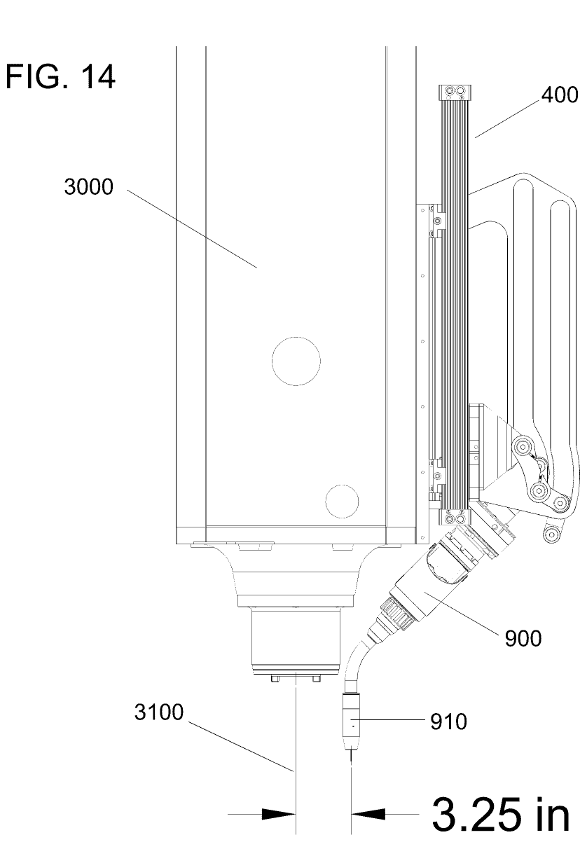

It is noted that the profile of cam track 10 and cam track 20 can be altered to affect the motion characteristics of the carriage assembly 700 and are key to providing the 2-stages of motion which allow the relationship between the spindle and torch/head to be kept close, as displayed in FIG. 14. The profile can be more specifically described as the total length, length of the linear section, length of the curved section, location of inflection point of the curved section along the total length and the radius of curvature of the curved section.

Cam plate 100 is made of a rigid material such as metal, like aluminum (Al), various aluminum alloys, various steels, various stainless steels, other alloys, a rigid plastic or a rigid composite material.

The first embodiment, shown in FIG. 1, is configured to have 2 cam plates 100 on opposite side of carriage assembly 700 mounted to mount 800. The second embodiment, shown in FIGS. 1A and 6A, is configured to have only one, single cam plate 100 mounted to mount 800. In both the first embodiment and second embodiment, cam plate 100 guides the 2-stage motion of carriage assembly 700. In the case of one or two cam plates 100, the 2-stage motion of the carriage assembly 700 is the same. More cam plates 100 of various shapes and sizes can be added to the deployment mechanism 1000 to alter the motion of the carriage assembly 700.

### Cam Plate Linkage

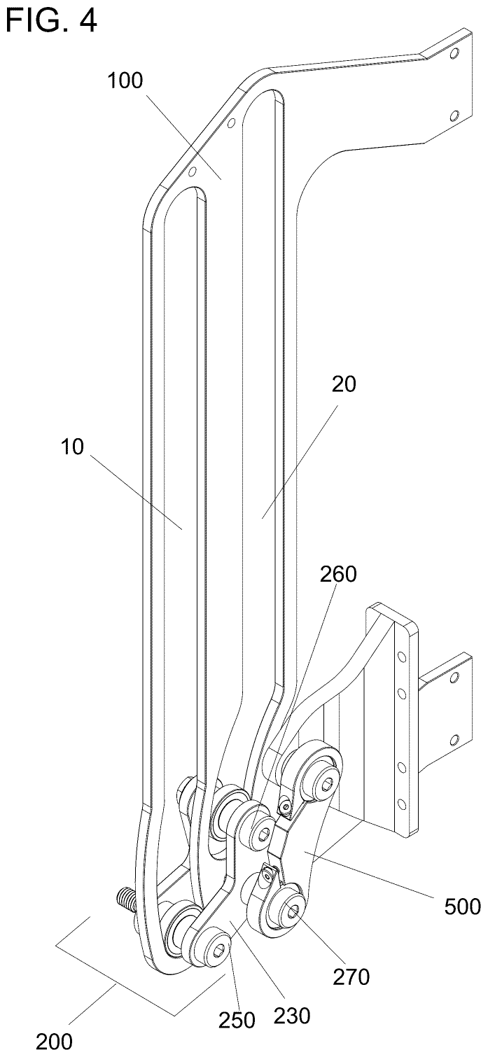

The main function of cam plate linkage 200 is to be an articulated linkage and to mechanically and rotatably couple tool mounting assembly 300 on one side of cam plate 100 to linear actuator linkage 500 on an opposite side of cam plate 100. FIGS. 4-7 and 10 show the details of cam plate linkage 200.

FIG. 4 shows a perspective view of cam plate linkage 200 in cam plate 100 and coupled to linear actuator linkage 500 on one side of cam plate 100.

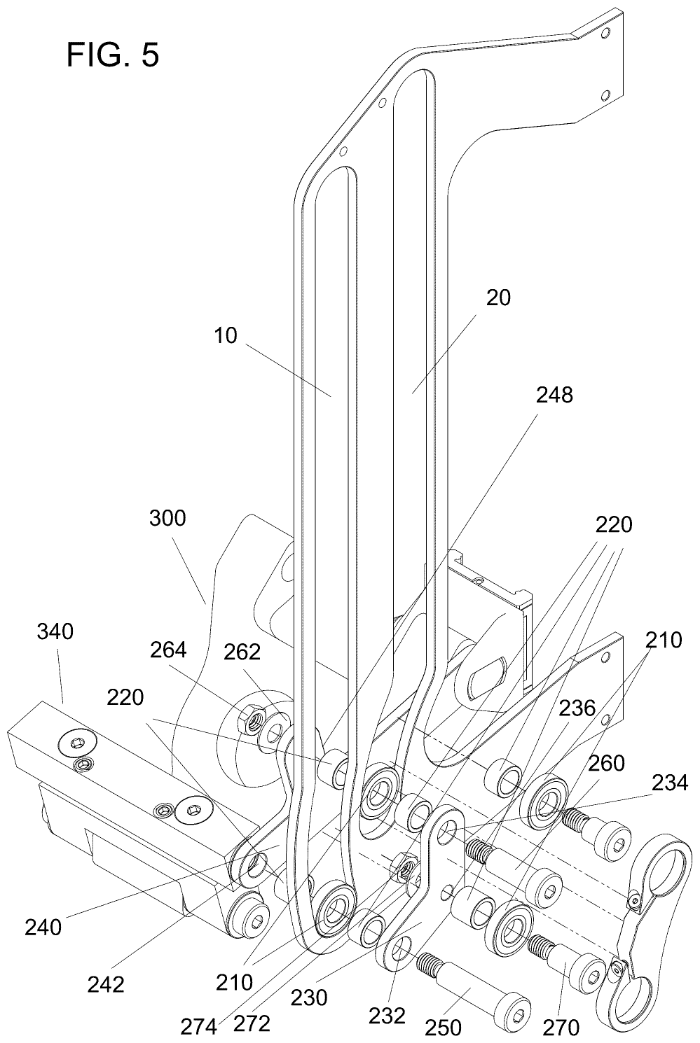

FIGS. 5 and 6 show perspective views cam plate linkage 200 from opposite sides of cam plate 100. Cam plate linkage 200 consists of the following parts:
two ring-shaped rollers 210, which can be ball bearing rollers, with one ring-shaped roller 210 moveably and rotatably in contact with inside surfaces of each cam track 10 and 20;
a spacer ring 220 on each side of roller 210 in contact with roller 210 to facilitate the rotation of roller 210;
a boomerang-shaped link plate 230 on one side of cam plate 100 with a hole 232 at one end of a boomerang-shaped link plate 230 and a hole 234 at an opposite end of the boomerang-shaped link plate 230;
a linear-shaped link plate 240 on the opposite side of cam plate 100 with a hole 242 at one end of linear-shaped link plate 240 and a hole 244 located on a vertical extension part 248 of linear-shaped link plate 240;
a shoulder bolt 250 which passes through all of hole 232, spacer ring 220, ring-shaped roller 210 of cam track 10, another spacer ring 220 and hole 242 and is threaded into a hole on a tool angle adjustment block 340 of tool mounting assembly 300; and
a shoulder bolt 260 which passes through all of hole 234, spacer ring 220, ring-shaped roller 210 of cam track 20, another spacer ring 220 and hole 244 and a washer 262 and a nut 264 on the opposite side of linear-shaped link plate 240.

In addition, boomerang-shaped link plate 230 has a third hole 236 located in the middle of boomerang-shaped link plate 230. Linear-shaped link plate 240 also has a third hole 246 which located at an opposite end of linear-shaped link plate 240. The third holes 236 and 246 provide additional connection points on the linkages.

In the case of boomerang-shaped link plate 230, on one side is a spacer ring 220 and a ring-shaped roller 210 and a shoulder bolt 270. Shoulder bolt 270 passes through ring-shaped roller 210, spacer 220, hole 236 and a washer 272 and a nut 274 on the opposite side of boomerang-shaped link plate 230.

In the case of linear-shaped link plate 240, third hole 246 is connected to a pin or bolt 620 which mounts the tool mounting assembly 300 to a platform 610 movable along linear guiderails 600.

### Tool Mounting Assembly

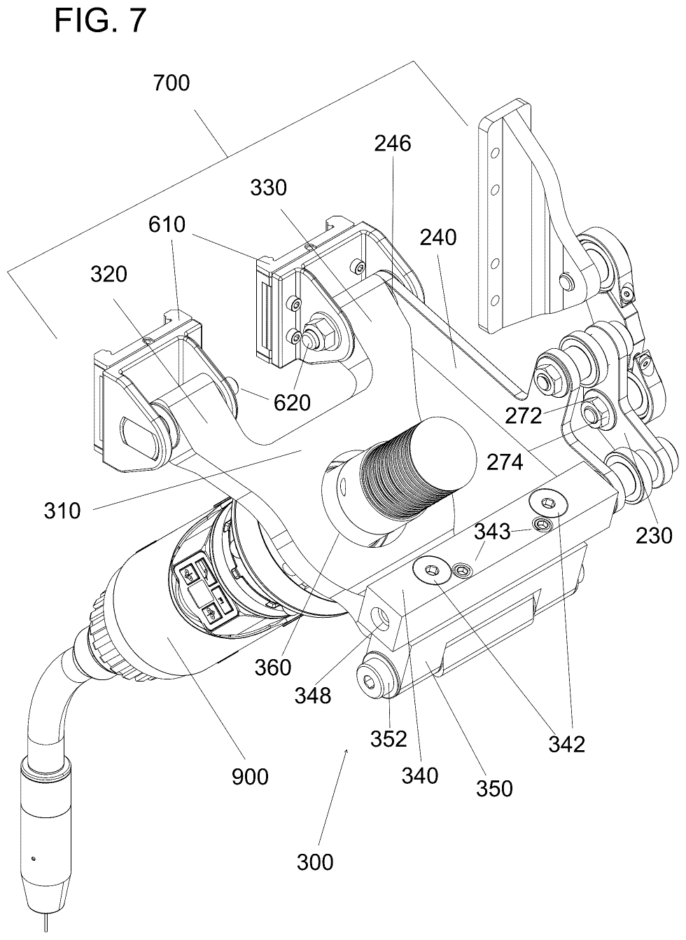

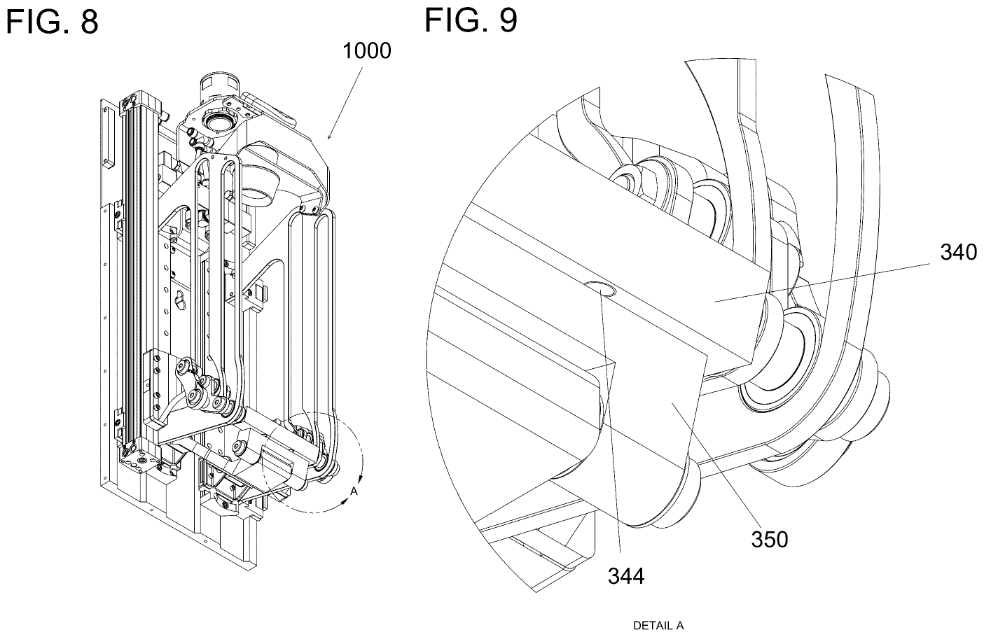

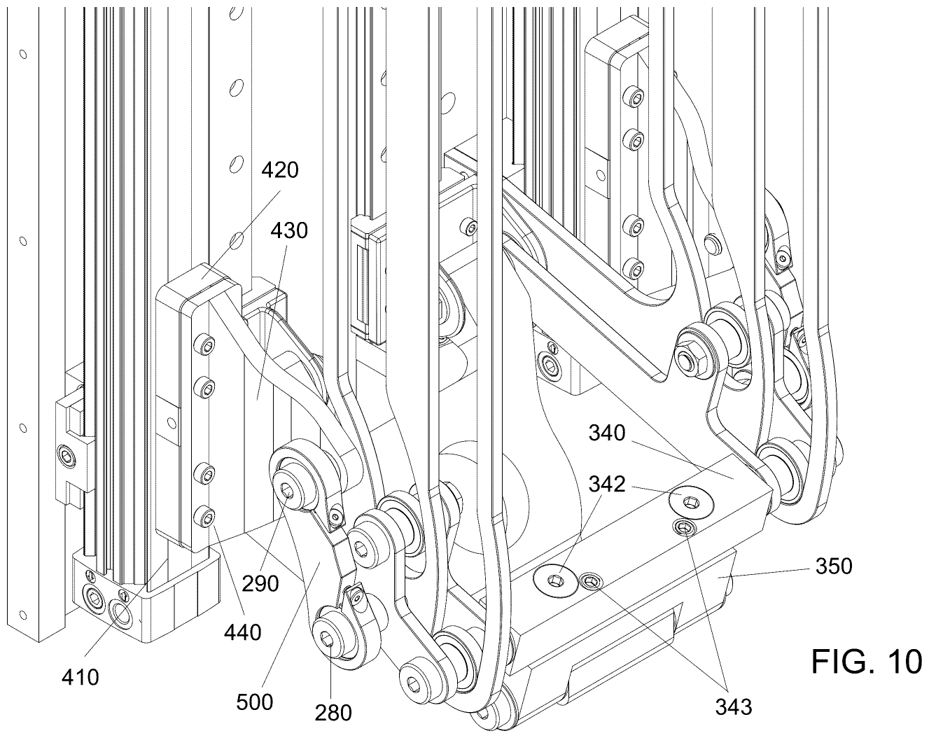

The main function of tool mounting assembly 300 is to mount/hold/couple the tool 900 for working on a workpiece, for example a welding head, to the deployment mechanism 1000. The tool mounting assembly 300 is shown in FIG. 7 holding a tool 900 and in shown FIG. 10 in the completely assembled deployment mechanism 1000.

Tool mounting assembly 300 consists of the following parts:
a tool mount plate 310 for mounting tool 900, the tool mount plate 310 having two extension arms 320 and 330 at one side for mounting to platforms 610 movable along linear guiderails 600 via pins or bolts 620;
a tool angle adjustment block 340 with flathead screw 342 and set screw 343 at an opposite side of tool mount plate 310, for adjusting an angle of tool 900;
a tool mount plate block 350 under the tool angle adjustment block 340, for mounting tool mount plate 310; and
a hole 360 in the middle of tool mount plate 310 for mounting tool 900.

Extension arms 320 and 330 are rotatably mounted via pins or bolts 620 to platforms 610 movable along linear guiderails 600 such that tool mount plate 310 has rotational motion for the movement of the tool mounting assembly 300 as well as for the fine angular adjustment of tool 900 by flathead screws 342 and set screws 343.

At the opposite side from extension arms 320 and 330, the tool angle adjustment block 340 of tool mount plate 310 is mounted to each of shoulder bolts 250 which threads through all of hole 232, spacer ring 220, ring-shaped roller 210 of cam track 10, another spacer ring 220 and hole 242 and is threaded into a hole 346 on the tool angle adjustment block 340.

The tool mount plate block 350 is located directly under the tool angle adjustment block 340 and mounted directly thereto. The tool mount plate block 350 is for rotatably mounting tool mount plate 310 with means such as pins, screws or bolts 352. The tool mount plate 310 is rotatably mounted directly under tool angle adjustment block 340, such that angle of tool mount plate 310 can be adjusted to ensure that the tip of tool 900 is vertical to the workpiece or machine table. The fine angle adjustment is performed by flathead screws 342 and set screws 343 shown in FIG. 10. The flathead screws 342 pull tool angle adjustment block 340 down and tool mount plate block 350 up. The set screws 343 push tool angle adjustment block 340 up and tool mount plate block 350 down. By adjusting both flathead screws 342 and set screws 343 in unison, the torch/head of tool 900 which is mounted to the tool mount plate block 350, can be adjusted up or down around a rotation axis to ensure the nozzle of tool 900 is vertical to the workpiece or machine table. Additionally, there can be a dowel pin (not shown), between tool angle adjustment block 340 and tool mount plate block 350 to constrain the joint and increase rigidity. FIG. 9 shows the detail of the bottom of set screw 343.

### Linear Actuator

The main function of the linear actuator 400, as shown in FIGS. 1, 1A, 2 and 11-14, is to provide the force to move the carriage assembly 700 within the deployment mechanism 1000 along cam tracks 10 and 20 and linear guide rails 600 to achieve two stage motion of the tool 900, for example the welding head. The linear actuators are operably connected to a power source (not shown), which can be a pneumatic, a hydraulic, an electric (alternating current (AC) or a direct current (DC)) or mechanical power source for actuating linear actuators 400.

A pair of linear actuators 400 are shown in FIG. 1. A single linear actuator 400 is shown in FIG. 1A, in the second embodiment of the invention.

Each linear actuator 400 is a pneumatic linear actuator connected to a power source (not shown).

Each linear actuator 400 consists of a linear actuator track 410 with a mounting block 420 which rides in linear actuator track 410. Each mounting block 420 of each linear actuator track 410 moves simultaneously together in the same direction when the linear actuators 400 move.

Mounting block 420 has attached thereon a connection plate 430 for the purpose of providing an attachment between the linear actuators, via mounting block 420, and carriage assembly 700. Connection plate 430 is a plate made of rigid material like metal, such as aluminum or aluminum alloy, secured to mounting block 420 by fasteners 440.

While linear actuators 400 can use any energy source for motion, a typical example is a pneumatic linear actuator, also known as ‘Rodless Cylinders’ or a Servo motor to provide the motive force for actuating the device. A specific example is a pressure regulator, a ‘5/2’ double solenoid-actuated pneumatic spool valve 450 with ‘flow control valves’, shown in FIG. 2, to limit the speed and force of torch/head movement for pneumatic applications.

### Linear Actuator Linkage

The main function of the linear actuator linkage 500, as shown in FIGS. 1, 1A, 4 and 10, is to movably and rotatably couple the connection plate 430 of the linear actuators 400 to the cam plate linkages 200 for the purpose of moving the carriage assembly 700 along the cam plates 100 and linear guiderails 600.

The linear actuator linkage 500 is a rotatable link coupling the connection plate 430 to the boomerang-shaped link plate 230 of the cam plate linkages 200.

At one end of linear actuator linkage 500 is a shoulder bolt 280 which threads through linear actuator linkage 500, ring-shaped roller 210, spacer 220, third hole 236 of boomerang-shaped link plate 230 and washer 272 and nut 274 on the opposite side of boomerang-shaped link plate 230.

At the other end of linear actuator linkage 500 is a shoulder bolt 290 which threads through linear actuator linkage 500, ring-shaped roller 210, spacer 220 and connection plate 430.

The linear actuator linkages 500 are the mechanical, rotatable couple between the linear actuator 400 and carriage assembly 700. Linear actuator linkages 500 are made of a rigid material and are designed transmit the forces from the linear actuators 400 to the cam plate linkages 200 in order to move the carriage assembly 700.

### Carriage Assembly

The combination of cam plate linkages 200 connected to tool mounting assembly 300 further connected to platforms 610 comprise a substructure referred to as a carriage assembly 700, as shown in FIG. 7. The carriage assembly 700 rolls or slides along cam plates 100 via the ring-shaped rollers 210, it also slides along linear guiderails 600 via the platforms 610 and the carriage assembly is subject to push and pull forces by the linear actuators 400 via the linear actuator linkages 500.

### Linear Guiderails

The main function of the linear guiderail 600 is to provide a stable, rigid track to guide the deployment mechanism 1000 while it moves due to the motion of the linear actuators 400. A pair of linear guide rails 600 are shown in FIG. 2. The invention can have one or more linear guide rails to guide the motion of carriage assembly. The one or more linear guiderails provides stability for the carriage assembly and its motion.

Upon linear guiderails 600 are platforms 610 which slidably engage the linear guiderails 600 to provide a rigid track for carriage assembly 700. Platforms 610 are connected to each of two extension arms 320 and 330 of tool mount plate 310 and form part of the carriage assembly 700.

### Housing

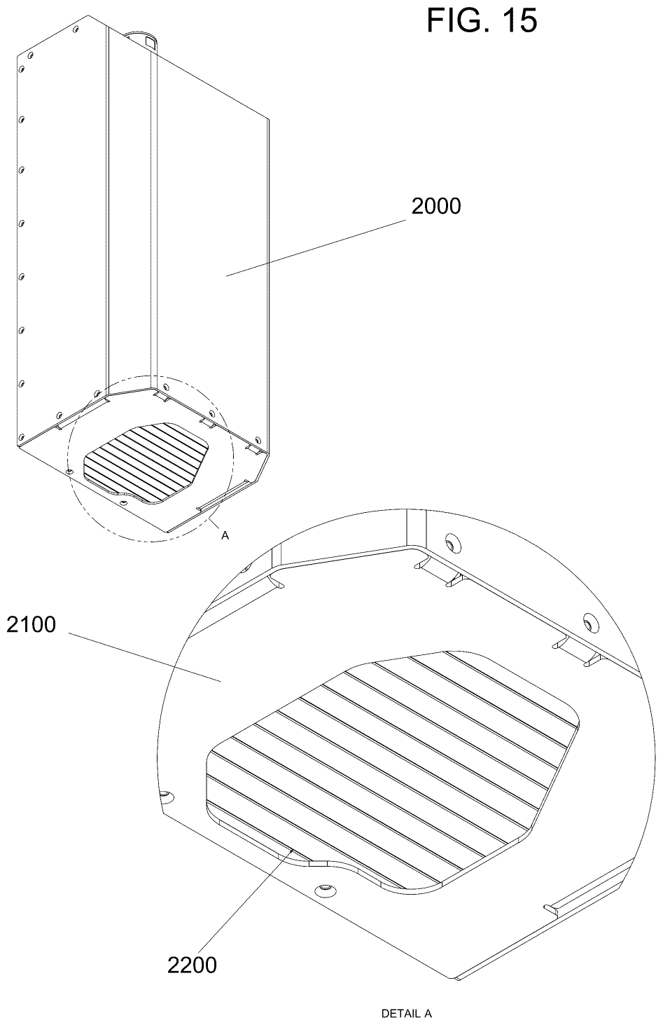

The main function of housing 2000, as shown in FIG. 15, is to enclose deployment mechanism 1000 when it is fully retracted to protect the touch/head from contamination and debris. Housing 2000 can be attached to mount 800 so that the deployment mechanism 1000 along with housing 2000 can be easily installed on the side of a spindle 3000. FIG. 14 shows the deployment mechanism 1000 mounted on the side of spindle 3000 without housing 2000.

Housing 2000 can completely surround and enclose deployment mechanism 1000 with top, bottom and side panels. Housing 2000 can be made of a sturdy material like metal. Housing 2000 can have a bottom panel 2100 shown with a movable door 2200. Movable door 2200 can be retracted when deployment mechanism 1000 moves to engage the tool 900 with a workpiece.

Movable door 2200 can move automatically in timing and coordination with the action of linear actuators 400 so that tool 900 of deployment mechanism 1000 can move in and out of housing 2000 rapidly without contacting movable door 2200.

When the carriage assembly 700 of deployment mechanism 1000 is fully retracted it is at the top of linear actuators 400 in the vertical orientation. The linear actuators 400 can have a lock position when the carriage assembly 700 of deployment mechanism 1000 is fully retracted so that carriage assembly 700 will not move along the linear actuators 400 without receiving a signal or instruction to do so. Furthermore, housing 2000 can have lock pins (not shown) which can be inserted from the outside of the housing through holes in housing 2000 into the deployment mechanism 1000 to provide a physical barrier or physical stop which prohibits movement. This can be useful for example when transporting deployment mechanism 1000.

### Two Stage Motion

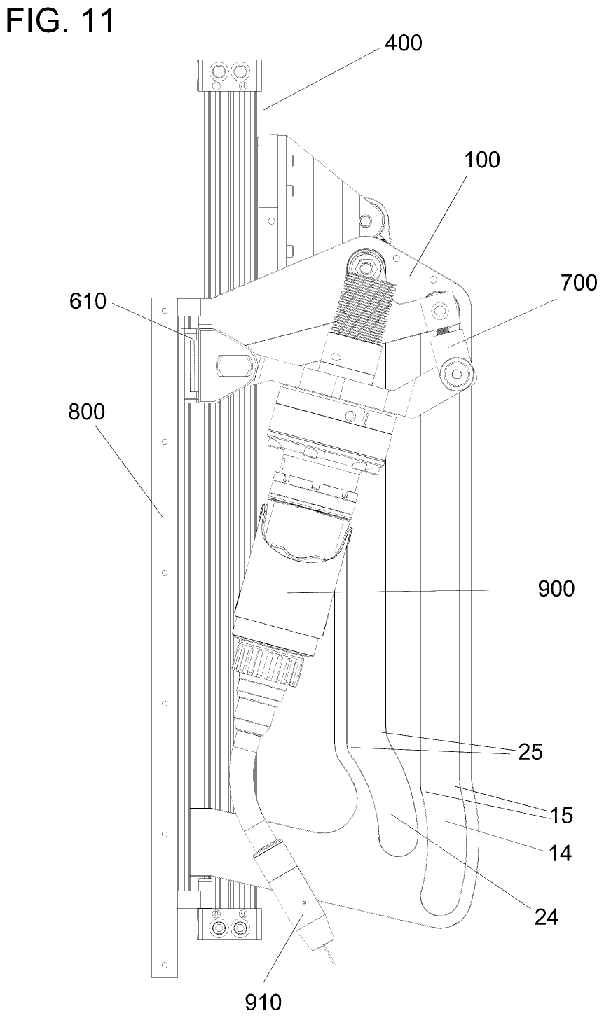

The operation of the deployment mechanism 1000 for tool 900, such as a welding head, is shown in FIGS. 11-14. Deployment mechanism 1000 has two stages of motion, Stage 1 and Stage 2. Stage 1 motion is linear and the tool 900 does not change orientation other than moving linearly. Stage 2 motion is angular motion where the tool 900 moves through an angle of rotation typically from about 20° to about 60°, including angles of about 25°, 27.5°, 30°, 32.5°, 35°, 37.5°, 40°, 42.5°, 45°, 47.5°, 50°, 52.5°, and 55°. The two stages of motion are distinctly Stage 1 linear motion and Stage 2 angular motion. The two stages of motion are the result of the carriage assembly 700 moving along the uniquely shaped cams 10 and 20 of cam plate 100.

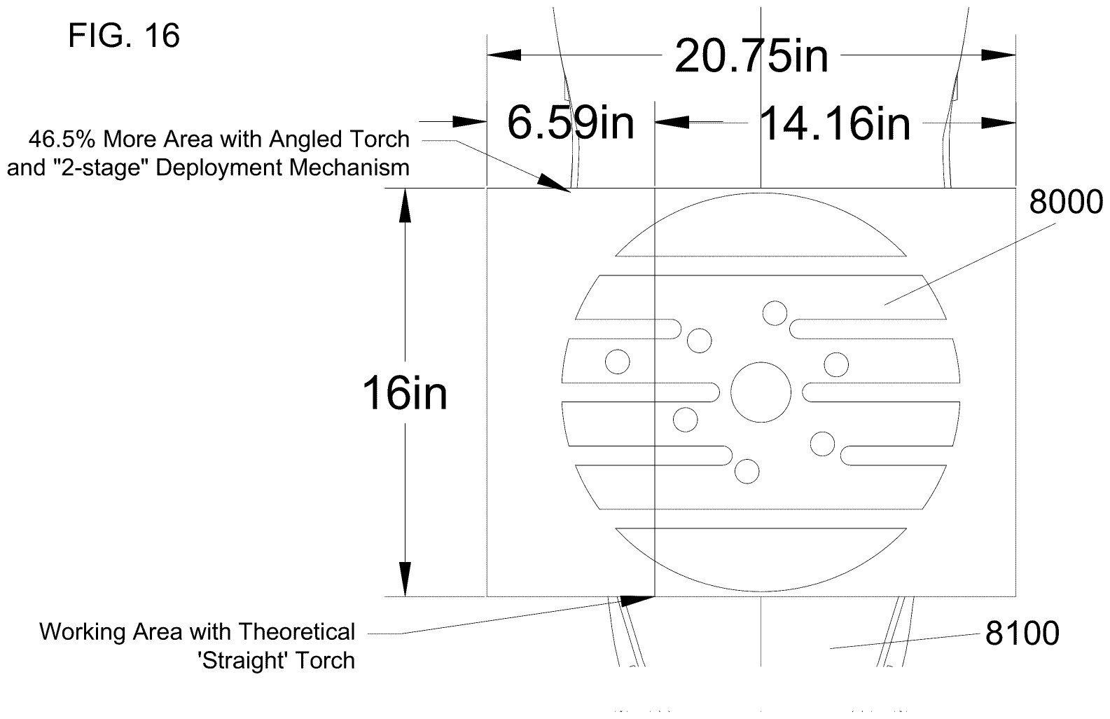

FIG. 11 shows tool 900 with welding torch/head 910 in the “Fully Retracted (Stowed) Position.” In this position, the two ring-shaped rollers 210 of cam plate linkages 200 are in contact with the rounded ends of linear section 12 and 22 of cam tracks 10 and 20 respectively. Platforms 610 of carriage assembly 700 are at the ends of linear guiderails 600 furthest from the machine table 8000, show in FIG. 16, which secures a workpiece. The linear actuator mounting blocks 420 and connection plates 430 are also located at the ends of the linear actuators 400 furthest from the machine table. In the vertical orientation of FIG. 11 the “Fully Retracted (Stowed) Position” is depicted as the position where carriage assembly 700 is at the vertical upper end of cam plates 100. However, if in a horizontal application, the “Fully Retracted (Stowed) Position” would simply be the position furthest form the machine table 8000 or work surface.

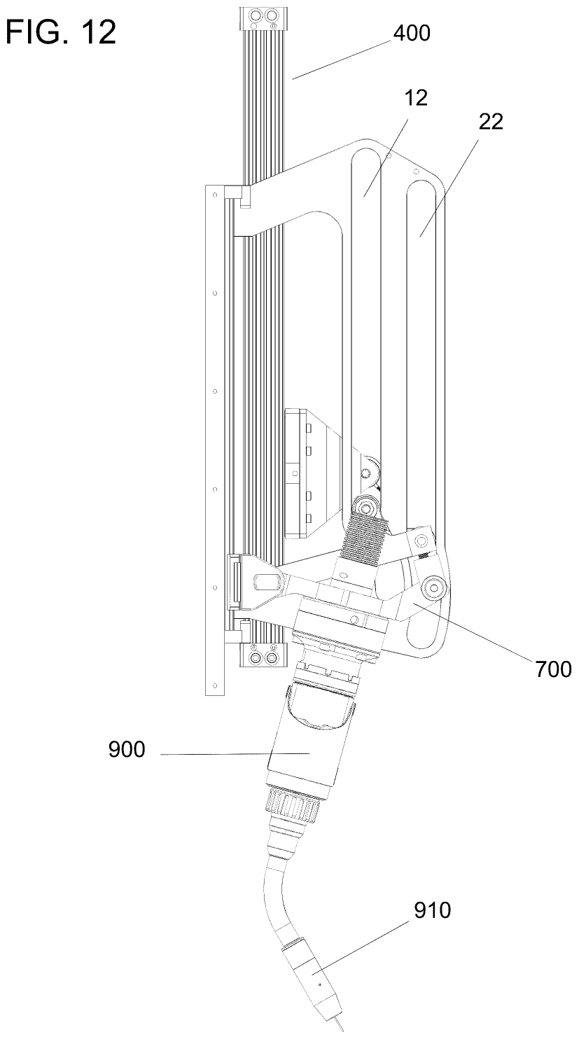

FIG. 11 shows the starting point of Stage 1 motion if the carriage assembly 700 is moving vertically down and shows the ending point of Stage I motion if the carriage assembly 700 is moving vertically up. Stage I motion is the linear motion along cam tracks 10 and 12 from the ends linear sections 12 and 22 to cam track inflection points 15 and 25 respectively. In vertical motion moving down, FIG. 11 shows the starting point of Stage I motion and FIG. 12 shows the ending point of Stage 1 motion where the carriage assembly 700 is depicted at cam track inflection points 15 and 25 and tool 900 has not changed its angular orientation.

FIG. 12 shows tool 900 with welding torch/head 910 at the end of Stage-1. This is the “Mid-Position” of the deployment mechanism 1000. In the vertical orientation of FIG. 12, the tool 900 with welding torch/head has moved down vertically and is at the end of Stage 1 linear motion prior to the action of inflection points 15 and 25 of cam tracks 10 and 20 respectively on cam plate 100. The end point of Stage 1 linear motion is the starting point of Stage 2 angular motion.

FIG. 12 shows the starting point of Stage 2 angular motion where the carriage assembly 700 is depicted at cam track inflection points 15 and 25 and tool 900 has not changed its angular orientation. As carriage assembly 700 moves along cam tracks 10 and 20 past cam track inflection points 15 and 25, the torch/head 910 of tool 900 moves from a starting position to an angle of about 20° to about 60°, including angles of about 25°, 27.5°, 30°, 32.5°, 35°, 37.5°, 40°, 42.5°, 45°, 47.5°, 50°, 52.5°, and 55° depending on the angle of the torch/head 910 neck and the distance needed to move the torch/head 910 into vertical orientation above the work surface. This movement of the carriage assembly 700 along the curved sections 14 and 24 of cam tracks 10 and 20 is the Stage 2 angular motion.

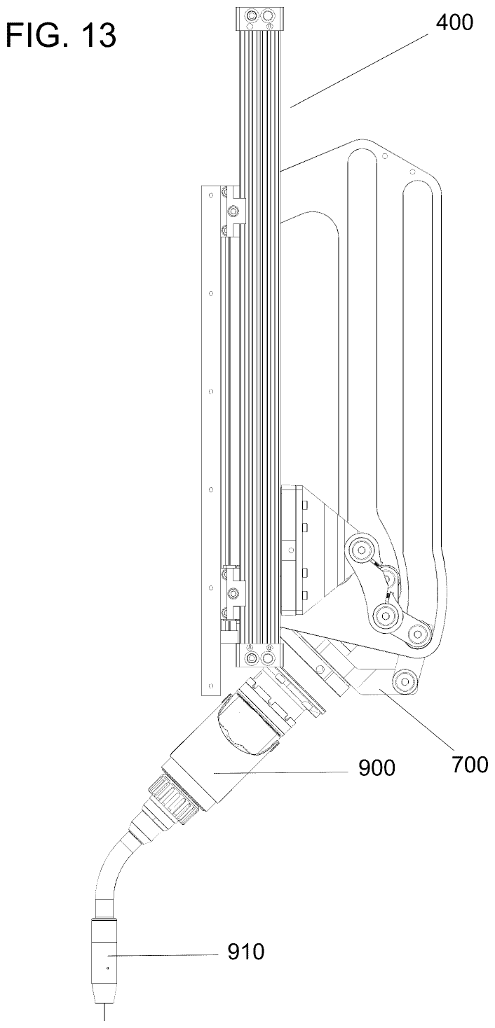

FIG. 13 shows tool 900 with welding torch/head 910 in the fully extended “Working Position.” The motion has completed Stage-2 angular motion and has pivoted/rotated into position near the spindle centerline of the machine for performing work on a work piece. In this position, the two ring-shaped rollers 210 of cam plate linkages 200 are in contact with the rounded ends of curved sections 14 and 24 of cam tracks 10 and 20 respectively. Platforms 610 of carriage assembly 700 are at the ends, or defined stop points near the ends, of linear guiderails 600 closest to the machine table which secures a workpiece. The linear actuator mounting blocks 420 and connection plates 430 are also located at the ends, or defined stop points near the ends, of the linear actuators 400 closest to the machine table. In the vertical orientation of FIG. 13 the “Working Position” is depicted as the position where carriage assembly 700 is at the vertical lower end of cam plate(s) 100. However, if in a horizontal application, the “Working Position” would simply be the position closest to the machine table or work surface.

FIGS. 11 and 12 depict tool 900 with welding torch/head 910 held at an angle relative to the linear actuator 400, for example. If the liner actuator 400 has no angle, then tool 900 with welding torch/head 910 is positioned at an angle relative to liner actuator(s) 400. Additionally torch/head 910 is also angled compared with the body of tool 900. Thus if, for example, torch/head 910 is held at an angle of about 15° compared to the vertical liner actuator(s) 400 and the 2-stage motion moves the tool 900 through an angle of about 30°, then the angled torch/head 910 can achieve a total angle of about 45° due to the combination of its shape and the unique 2-stage motion of the deployment mechanism 1000. FIG. 14 shows torch/head 910 vertical and parallel with spindle center 3100 and the end of the 2-stage motion.

FIG. 14 shows that the relationship between the spindle 3000 and spindle centerline 3100 (left) and the torch/head 910 (right) is minimized. This would be impossible to achieve without the ‘2-Stage’ motion of the device. The 2-stage motion allows the torch/head 910 to get within about 2-5″ of the spindle centerline 3100.

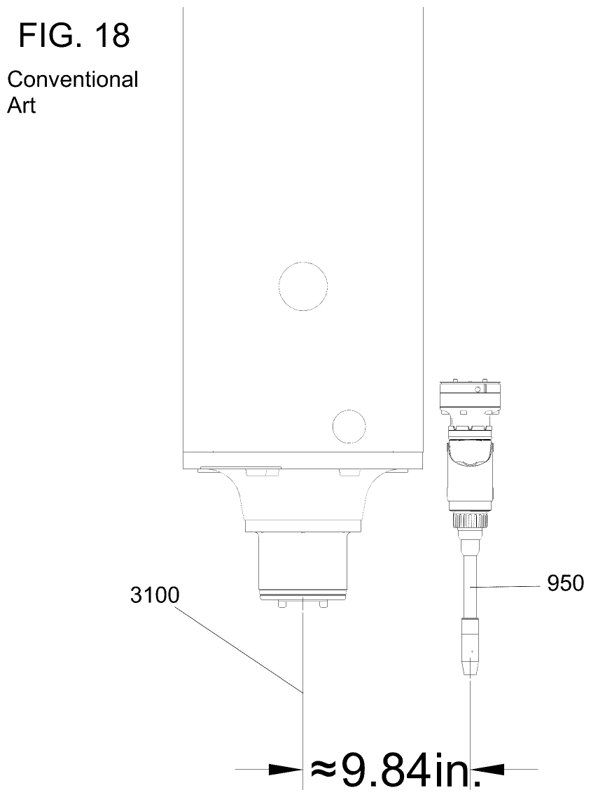

FIG. 16 shows a layout drawing that represents the total area that can be reached by both the torch/head 910 mounted on the ‘2-Stage’ deployment mechanism 1000 and the spindle 3000. The layout of FIG. 16 is a bird's eye view of a machine table 8000 of a milling machine, for example a CNC machine, which is connected to a saddle 8100, a U-shaped rotatable part of the CNC machine which holds the machine table 8000. The machine table 8000 is for securing a work piece. The spindle 3000 is positioned above the machine table. In FIG. 18, the straight torch 950 is depicted adjacent to the spindle 3000 with the straight torch 950 separated from the centerline 3100 of the spindle 3000 by 9.84 inches. In FIG. 14, the torch/head 910 mounted on the ‘2-Stage’ deployment mechanism 1000 is depicted adjacent to the spindle 3000 with the torch/head 910 separated from the centerline 3100 of the spindle 3000 by 3.25 inches. FIG. 16 is one example based on a 20.75 inch×16 inch outline of the normal travel of the machine spindle 3000. The actual distances are just for example only, as the distances can vary depending on the size of the device for performing work on workpieces. In this example, the 14.16 inch×16 inch outline represents the ‘shift’ in the working envelope with a ‘straight’ head/torch 950 (shown in FIG. 18). The additional 6.59 inch×16 inch outline represents the additional area reachable by the head/torch 910 in the working envelope with an ‘angled’ head/torch 910 mounted on the ‘2-Stage’ deployment mechanism 1000 of the present invention. The 14.16 inch×16 inch area is the total area that a straight torch, as shown in FIG. 18, can cover. Without the ‘2-Stage’ mechanism, the torch cannot cover the entire machine table 8000. The 6.59 inch×16 inch area depicts the additional ‘overlap’ in usable machine envelope achievable with the ‘2-Stage’ deployment mechanism 1000. The torch can now cover the entire machine table 8000 and retain 86.5% of the machine envelope; 46.5% more than with the ‘straight’ torch. This example is for a Haas UMC-500ss machine. These dimensions are subject to change based on the machine model.

FIG. 18 shows the conventional relationship between the spindle centerline 3100 (left) and the straight torch/head 950 (right) with a ‘straight’ torch and a linear ‘up/down’ mechanism. In this example, 9.84 inches is the minimum distance between the straight torch/head 950 and the spindle centerline 3100 without the ‘2-stage’ rotation and an angled torch of deployment mechanism 1000.

### Accessory Plate

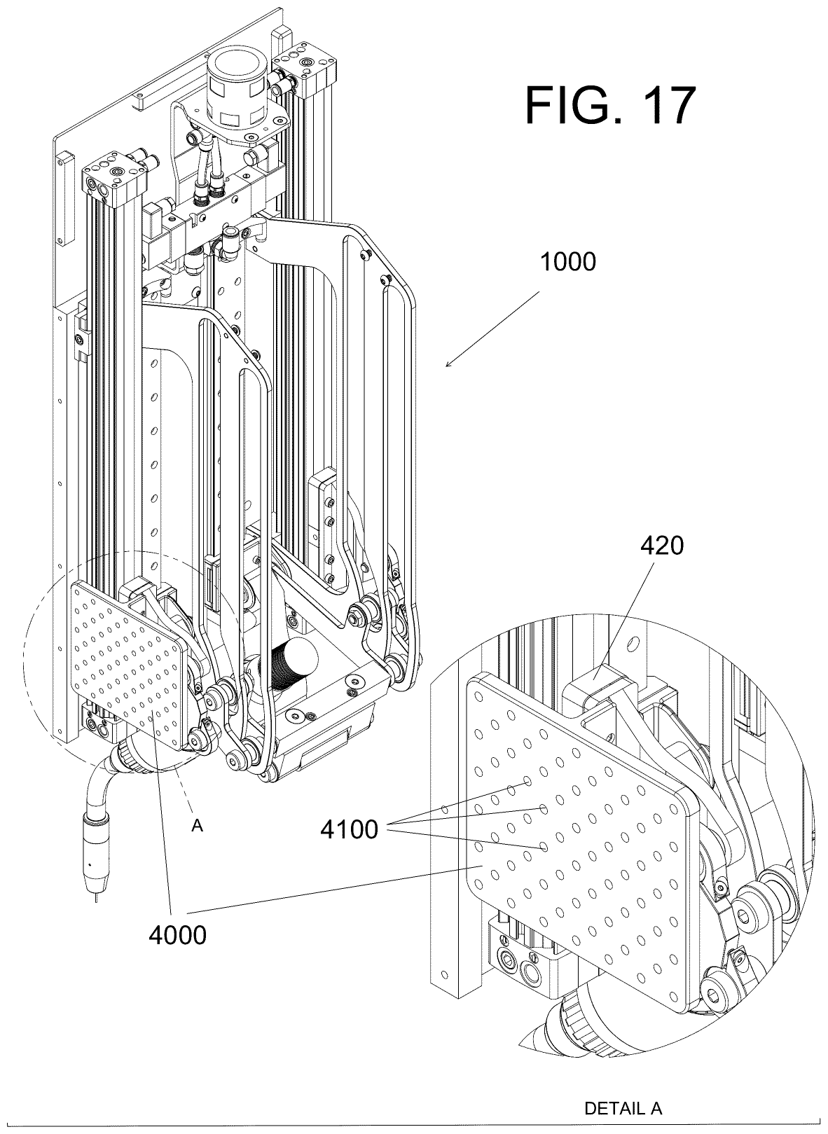

FIG. 17 shows the invention with an accessory plate 4000 attached to the mounting block 420 of linear actuator 400. Accessory plate 4000 can also be directly attached to the linear actuator 400. Accessory plate 4000 has holes 4100 arranged in a grid pattern for mounting accessories such as image devices, vision cameras, thermal sensors, IR sensors, welding microphone, laser scanner, distance measurement sensors, sensors including temperature, motion, position and various other devices for obtaining, sending and receiving data. More than one accessory plate, of various shapes and sizes, can be mounted to deployment mechanism.

Accessory plate 4000 can also be equipped with a cable management device to restrain and protect the cables, wires, hoses, or lines of any image devices or sensors mounted on the accessory plate.

FIG. 17 shows accessory plate 4000 with the first, two cam plates, embodiment of the invention, but accessory plate 4000 can be mounted just the same on the second, single cam plate, embodiment of the invention shown in FIGS. 1A and 6A.

### Operation and Effects

The effects of the deployment mechanism 1000 for a welding head of the present invention are as follows:
Accurately, rigidly, and repeatably extend the torch/head into position;
Position the torch/head as close as possible to the machine tool spindle centerline to reduce the amount of offset and machine travel between the torch/head and the spindle;
Adequately store, enclose, and/or protect the torch from contamination or debris (such as machine coolants, oils, and metal chips from machining);
Monitor the position of the torch/head to ensure it is fully extended or retracted prior to continuing operation;
Facilitate fine adjustment of the torch/head angle in the ‘working position’;
Provide different design configurations for different use applications depending on the number of cam plate(s) used in the structural design.
   The key benefits of the deployment mechanism 1000 are as follows:
The close relationship of the torch/head to the spindle provides a greater useable envelope to perform both machining and welding compared to a ‘straight’ Torch and a simple ‘up/down’ mechanism.
The compactness of the mechanism enables it to be installed in the machine without having to limit machine travel or drastically alter the sheet metal enclosure of the machine. This also contributes to the usable working envelope of the machine as the overall machine travel is not impacted or reduced.

### Programable Control and Feedback Control

As will be appreciated by those skilled in the art, aspects of the present disclosure may be embodied as a system, method or computer program product. Accordingly, aspects of this disclosure may take the form of an entirely hardware embodiment, an entirely software embodiment (including firmware, resident software, micro-code, etc.), or an embodiment combining software and hardware aspects, all possibilities of which can be referred to herein as a “circuit,” “module,” or “system.” A “circuit,” “module,” or “system” can include one or more portions of one or more separate physical hardware and/or software components that can together perform the disclosed function of the “circuit,” “module,” or “system”, or a “circuit,” “module,” or “system” can be a single self-contained unit (e.g., of hardware and/or software). Furthermore, aspects of this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of this disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of this disclosure may be described above with reference to flowchart illustrations and/or block diagrams of methods, apparatus (systems) and computer program products according to embodiments of this disclosure. It will be understood that each block of any flowchart illustrations and/or block diagrams, and combinations of blocks in any flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in any flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

Additionally a controller or control module can be operatively connected to receive signals indicative of welding temperature, ambient temperature, torch/head position, workpiece position, for example, from one or more sensors, and a feedback module configured to analyze the sensor data and output a feedback signal to the controller to generate and alarm and automatically shut off relevant parts the system and or the device working on the workpiece on the basis of the analyzed sensor data.

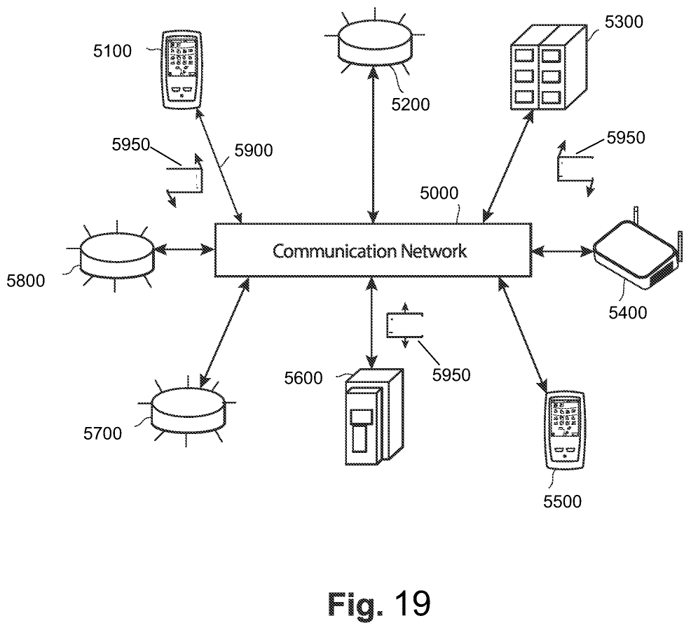

FIG. 19 depicts an exemplary communications network 5000 in which below illustrated embodiments may be implemented. It is to be understood a communication network 5000 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 19 is a schematic block diagram of an example communication network 5000 illustratively comprising nodes/devices 5100-5800 (e.g., displays 5100, sensors 5200, client computing devices 5300 (e.g., network monitoring devices), WiFi routers 5400, smart phone devices 5500, web servers 5600, routers 5700, switches 5800, databases, and the like) interconnected by various methods of communication. For instance, the links 5900 may be wired links or may comprise a wireless communication medium, where certain nodes are in communication with other nodes, e.g., based on distance, signal strength, current operational status, location, etc. Moreover, each of the devices can communicate data packets (or frames) 5950 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

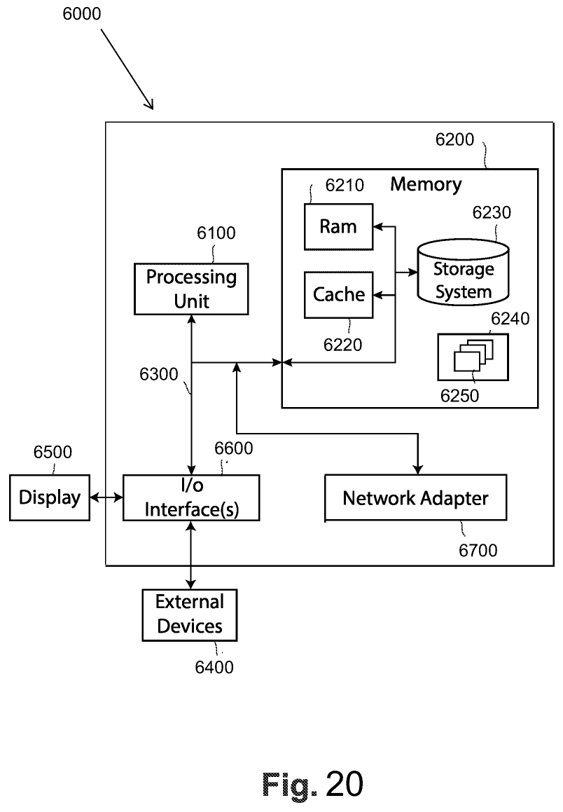

FIG. 20 is a schematic block diagram of an example network computing device 6000 (e.g., client computing device 5300, server 5600, etc.) that may be used (or components thereof) with one or more embodiments described herein (e.g., as one of the nodes shown in the network 5000) for determining the probability of an incident occurring to one or more computer applications resulting from one or more application change attributes through implementation of machine learning (ML) techniques. As explained above, in different embodiments these various devices are configured to communicate with each other in any suitable way, such as, for example, via communication network 5000.

Device 6000 is intended to represent any type of computer system capable of carrying out the teachings of various illustrated embodiments. Device 6000 is only one example of a suitable system and is not intended to suggest any limitation as to the scope of use or functionality of the illustrated embodiments described herein. Regardless, computing device 6000 is capable of being implemented and/or performing any of the functionality set forth herein, particularly for creating, and executing feedback control in accordance with the illustrated embodiments.

The components of device 6000 may include, but are not limited to, one or more processors or processing units 6100, a system memory 6200, and a bus 6300 that couples various system components including system memory 6200 to processor 6100. Bus 6300 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Computing device 6000 typically includes a variety of computer system readable media. Such media may be any available media that is accessible by device 6000, and it includes both volatile and non-volatile media, removable and non-removable media.

System memory 6200 can include computer system readable media in the form of volatile memory, such as random-access memory (RAM) 6210 and/or cache memory 6220. Computing device 6000 may further include other removable/non-removable, volatile/non-volatile computer system storage media. By way of example only, storage system 6230 can be provided for reading from and writing to a non-removable, non-volatile magnetic media (not shown and typically called a “hard drive”). Although not shown, a magnetic disk drive for reading from and writing to a removable, non-volatile magnetic disk, and an optical disk drive for reading from or writing to a removable, non-volatile optical disk such as a CD-ROM, DVD-ROM or other optical media can be provided. In such instances, each can be connected to bus 6300 by one or more data media interfaces. As will be further depicted and described below, memory 6200 may include at least one program product having a set (e.g., at least one) of program modules that are configured to carry out the functions of embodiments of illustrated embodiments such as creating, and executing feedback control in accordance with the illustrated embodiments.

Program/utility 6240, having a set (at least one) of program modules 6250, such as underwriting module, may be stored in memory 6200 by way of example, and not limitation, as well as an operating system, one or more application programs, other program modules, and program data. Each of the operating system, one or more application programs, other program modules, and program data or some combination thereof, may include an implementation of a networking environment. Program modules 6250 generally carry out the functions and/or methodologies of the illustrated embodiments as described herein for creating, and executing feedback control in one or more networked computer devices (e.g., 5100, 5600).

Device 6000 may also communicate with one or more external devices 6400 such as a keyboard, a pointing device, a display 6500, etc.; one or more devices that enable a user to interact with computing device 6000; and/or any devices (e.g., network card, modem, etc.) that enable computing device 6000 to communicate with one or more other computing devices. Such communication can occur via Input/Output (I/O) interfaces 6600. Still yet, device 6000 can communicate with one or more networks such as a local area network (LAN), a general wide area network (WAN), and/or a public network (e.g., the Internet) via network adapter 6700. As depicted, network adapter 6700 communicates with the other components of computing device 6000 via bus 6300. It should be understood that although not shown, other hardware and/or software components could be used in conjunction with device 6000. Examples, include, but are not limited to: microcode, device drivers, redundant processing units, external disk drive arrays, RAID systems, tape drives, and data archival storage systems, etc.

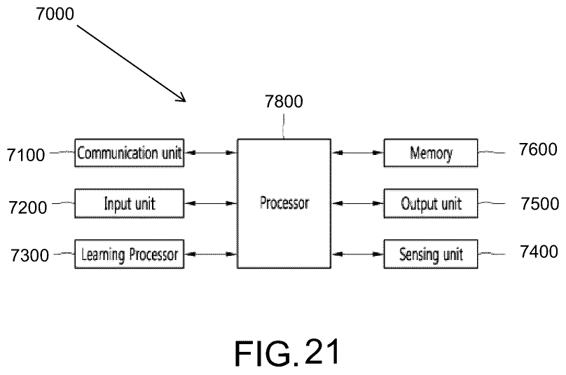

Referring now to FIG. 21, it illustrates a feedback control system 7000 according to an embodiment of the illustrated embodiments. The feedback control system 7000 may be implemented by a stationary device or a mobile device, such as a web server, a desktop computer, a notebook, a desktop computer, and the like.

In conjunction with FIGS. 19 and 20, the feedback control system 7000 of FIG. 21 is operatively coupled to, or integrated with computing device 6000, in accordance with the illustrated embodiments described herein. The feedback control system 7000 preferably includes a communication unit 7100, an input unit 7200, a learning processor 7300, a sensing unit 7400, an output unit 7500, a memory 7600, and a processor 7800. The communication unit 7100 may transmit and receive data to and from external devices, such as other feedback devices, by using wire/wireless communication technology. For example, the communication unit 7100 may transmit and receive historical and contemplated application change attributes, a user input, a learning model, and a control signal to and from external devices, such a server.

The output unit 7500 preferably includes a display unit for outputting/displaying relevant information to a user in accordance with the illustrated embodiments described herein. The memory 7600 preferably stores data that supports various functions of the feedback control system 7000. For example, the memory 7600 may store input data acquired by the input unit 7200, learning data, a learning model, a learning history, and the like.

The processor 7800 preferably determines at least one executable operation of the feedback control system 7000 based on information determined or generated by using a data analysis algorithm or a machine learning algorithm. The processor 7800 may control the components of the feedback control system 7000 to execute the determined operation. To this end, the processor 7800 may request, search, receive, or utilize time-based metric data of the learning processor 7300 or the memory 7600. The processor 7800 may control the components of the feedback control system 7000 to execute the predicted operation or the operation determined to be desirable among the at least one executable operation. When the connection of an external device is required to perform a determined operation, the processor 7800 may generate a control signal for controlling the external device and may transmit the generated control signal to the external device. The processor 7800 may acquire intention information for the user input and may determine the user's requirements based on the acquired intention information. In some embodiments, the processor 7800 may acquire the intention information corresponding to the user input by using at least one of a speech to text (STT) engine for converting speech input into a text string or a natural language processing (NLP) engine for acquiring intention information of a natural language.

In certain illustrated embodiments, at least one of the STT engine or the NLP engine may be configured as an artificial neural network, at least part of which is learned according to the machine learning algorithm. Thus, in certain illustrated embodiments, at least one of the STT engine or the NLP engine may be learned by the learning processor 7300 or may be learned by the learning processor 7400 of the feedback control system 7000, or may be learned by their distributed processing. The processor 7800 may collect history information including the operation contents of the feedback control system 7000 or the user's feedback on the operation and may store the collected history information in the memory 7600 or the learning processor 7300 or transmit the collected history information to an external device. The collected history information may be used to update the learning model.

The processor 7800 may control at least part of the components of feedback control system 7000 so as to drive an application program stored in memory 7600. Furthermore, the processor 7800 may operate two or more of the components included in the feedback control system 7000 in combination so as to drive the application program.

In one configuration of the present invention, the deployment mechanism 1000 can be operably combined with sensors 7400, processors 7800, memory 7600, device 6000, feedback control system 7000, programmable instructions and a communication network 5000, as described for FIGS. 19-21, to create a system whereby welding temperature, welding sound, ambient temperature, torch/head position, workpiece position can provide feedback data for the automatic operation the deployment mechanism 1000. For example data collected from one or more sensors can be output as a feedback signal to a controller to perform various functions automatically such as: to generate an alarm; to regulate current in a tool, such as a welding tool, used on the workpiece to avoid overheating the workpiece, or melting the workpiece; and automatically shut off the tool or tools working on the workpiece if maximum or minimum thresholds for temperature are exceeded or if there was some other kind of fault.

In another example, the deployment mechanism 1000 can be operably combined with sensors 7400, processors 7800, memory 7600, device 6000, feedback control system 7000, programmable instructions and a communication network 5000, as described for FIGS. 19-21, to create a system whereby an alarm can be generated if the deployment mechanism 1000 does not properly complete Stage 2 angular motion. In other words, the torch/head 910 is not properly aligned with the machine table and/or workpiece.

In another configuration of the present invention, the deployment mechanism 1000 can be operably combined with sensors 7400, processors 7800, memory 7600, device 6000, feedback control system 7000, programmable instructions and a communication network 5000, as described for FIGS. 19-21, to create a system whereby feedback data from various accessories such as image devices, vision cameras, thermal sensors, IR sensors, welding microphone, laser scanner, distance measurement sensors, sensors including temperature, motion, position and various other devices for obtaining, sending and receiving data, can be used for various operations such as: closed loop feedback control, quality control of parts, verified part geometry, or data confirmation. For example, data collected from one or more sensors can be output as a feedback signal to a controller to perform various functions automatically such as: operating or moving the welding torch/head, operating or moving the multi-axis CNC machine, ending the operation of the torch/head, adjusting parameters, and temporarily pausing operation for cooling, inter-pass machining, and torch/machine service intervals.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. A deployment mechanism for a tool with a torch/head comprising:
a mount, which is a plate for securing the parts the deployment mechanism directly or indirectly;
a cam plate with two cam tracks secured to the mount;
a carriage assembly comprising:
a cam plate linkage movably and rotatably connected to the cam plate, and
a tool mounting assembly for mounting the tool thereon, the tool mounting assembly being rotatably connected to the cam plate linkage;
a linear actuator secured to the mount; and
a linear actuator linkage for coupling the linear actuator with the carriage assembly;
whereby the carriage assembly can move by the action of the linear actuator along the two cam plate tracks and as a result move the tool into position above a workpiece.

2. A deployment mechanism for the tool with the torch/head according to claim 1, wherein each cam track of the cam plate has a linear section and a curved section, with the curved section of each cam track having different radii of curvature.

3. A deployment mechanism for the tool with the torch/head according to claim 2, wherein the linear sections of the cam tracks are parallel with each other and the curved sections of the cam tracks are not parallel with each other.

4. A deployment mechanism for the tool with the torch/head according to claim 1, wherein each cam track of the cam plate has a linear section extending to an inflection point along the cam track at which point the cam track curves continuously until the end, opposite the linear section, of the cam track is reached.

5. A deployment mechanism for the tool with the torch/head according to claim 1, whereby the deployment mechanism has two stages of motion, with Stage 1 motion being linear and Stage 2 motion being angular motion where the tool moves through an angle of rotation typically from about 20° to about 60°, including angles of 25°, 30°, 35°, 40°, 45°, 50°, and 55°.

6. A deployment mechanism for the tool with the torch/head according to claim 1, wherein the cam plate is made of a rigid material selected from the group consisting of: metal, aluminum (Al), various aluminum alloys, various steels, various stainless steels, other alloys, a rigid plastic and a rigid composite material.

7. A deployment mechanism for the tool with the torch/head according to claim 1, wherein the tool mounting assembly further comprises:
a tool mount plate for mounting the tool,
a tool angle adjustment block with adjusting screws connected to a tool mount plate block; and
the tool mount plate block under the tool angle adjustment block for mounting the tool mount plate.

8. A deployment mechanism for the tool with the torch/head according to claim 1, further comprising a housing to completely enclose the deployment mechanism when the tool is not deployed.

9. A deployment mechanism for the tool with the torch/head according to claim 1, further comprising an accessory panel for accessories attached to a mount on the linear actuator.

10. A deployment mechanism for a tool with a torch/head comprising:
a mount, which is a plate for securing the parts the deployment mechanism directly or indirectly;
a cam plate with two cam tracks secured to the mount;
a carriage assembly comprising:
a cam plate linkage movably and rotatably connected to the cam plate, and
a tool mounting assembly for mounting the tool thereon, the tool mounting assembly being rotatably connected to the cam plate linkage and movably connected to a linear guide rail;
a linear actuator secured to the mount;
a linear actuator linkage for coupling the linear actuator with the carriage assembly; and
the linear guiderail secured to the mount and movably connected to the tool mounting assembly;
whereby the carriage assembly can move by the action of the linear actuator along the two cam plate tracks and as a result move the tool into position above a workpiece.

11. A deployment mechanism for the tool with the torch/head according to claim 10, wherein each cam track of the cam plate has a linear section and a curved section, with the curved section of each cam track having different radii of curvature.

12. A deployment mechanism for the tool with the torch/head according to claim 11, wherein the linear sections of the cam tracks are parallel with each other and the curved sections of the cam tracks are not parallel with each other.

13. A deployment mechanism for the tool with the torch/head according to claim 10, wherein each cam track of the cam plate has a linear section extending to an inflection point along the cam track at which point the cam track curves continuously until the end, opposite the linear section, of the cam track is reached.

14. A deployment mechanism for the tool with the torch/head according to claim 10, whereby the deployment mechanism has two stages of motion, with Stage 1 motion being linear and Stage 2 motion being angular motion where the tool moves through an angle of rotation typically from about 20° to about 60°, including angles of 25°, 30°, 35°, 40°, 45°, 50°, and 55°.

15. A deployment mechanism for the tool with the torch/head according to claim 10, wherein the cam plate is made of a rigid material selected from the group consisting of: metal, aluminum (Al), various aluminum alloys, various steels, various stainless steels, other alloys, a rigid plastic and a rigid composite material.

16. A deployment mechanism for the tool with the torch/head according to claim 10, wherein the tool mounting assembly further comprises:
a tool mount plate for mounting the tool,
a tool angle adjustment block with adjusting screws connected to a tool mount plate block; and
the tool mount plate block under the tool angle adjustment block for mounting the tool mount plate.

17. A deployment mechanism for the tool with the torch/head according to claim 10, further comprising a housing to completely enclose the deployment mechanism when the tool is not deployed.

18. A deployment mechanism for the tool with the torch/head according to claim 10, further comprising an accessory panel for accessories attached to a mount on the linear actuator.

19. A system for a deployment mechanism for a tool with a torch/head with feedback control, the system comprising:
an operable assembly, in a single system, comprising:
a mount, which is a plate for securing the parts the deployment mechanism directly or indirectly;
a cam plate with two cam tracks secured to the mount;
a carriage assembly comprising:
a cam plate linkage movably and rotatably connected to the cam plate,
a tool mounting assembly for mounting the tool thereon, the tool mounting assembly being rotatably connected to the cam plate linkage, and
a sensor to determine the position of the carriage assembly;
a linear actuator secured to the mount; and
a linear actuator linkage for coupling the linear actuator with the carriage assembly; and
a processor, the processor being configured to:
receive data from the position sensor;
determine whether or not the tool is in the correct position when fully deployed;
generate an alarm if the tool is not in the correct position when fully deployed; and
send a signal to a device working on the workpiece to halt operation so that all work is terminated and no energy is transmitted to the tool.

20. The system for a deployment mechanism for the tool with the torch/head with feedback control according to claim 19, further comprising:
a sensor to determine the temperature of the workpiece;
a processor further configured to:
receive data from the temperature sensor;
determine the temperature;
determine if the temperature exceeds a maximum allowed pre-determined temperature;
generate an alarm if the temperature exceeds a maximum allowed pre-determined temperature; and
send a signal to a device working on the workpiece to halt operation so that all work is terminated and no energy is transmitted to the tool if the temperature exceeds a maximum allowed pre-determined temperature.
